(19) United States
(12) Patent Application Publication
(10) Pub. No.: US 2006/0123457 A1
(43) Pub. Date: Jun. 8, 2006

(54) Universal single chip set-top box

(75) Inventors: Joey Y. Chen, Irvine, CA (US); Joseph J. Fiorenza, Ladera Ranch, CA (US); Tony M. Turner, Foothill Ranch, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation

(21) Appl. No.: 11/046,232

(22) Filed: Jan. 31, 2005

Related U.S. Application Data
(60) Provisional application No. 60/632,620, filed on Dec. 3, 2004.

(51) Int. Cl. H04N 7/16

(52) U.S. Cl. 725/151

(57) ABSTRACT

A universal integrated set-top box is implemented on single semiconductor substrate. The set-top box includes video and audio baseband functions on the common substrate. The set-top box is a universal set-top box chip that can process and demodulate multiple different types of inputs including satellite, cable, Internet, or other device inputs. This can be accomplished because the set-top box does not have a specific tuner integrated on the substrate, and therefore can take generic down-converted inputs, e.g. MPEG packets. In other words, an external tuner/decoder (of any type) can be connected to the set-top box input for processing, including for example, a satellite tuner, cable tuner, or any other type of tuner/decoder that can produce digital outputs (e.g. MPEG packets) for further processing in a set-top box. The set-top box also includes Ethernet and USB connections so as to receive inputs from other set-top boxes, Internet device, or other devices, with similar types of connections.

### CROSS REFERENCED TO RELATED APPLICATIONS

This Application claims the benefit of U.S. Provisional Application No. 60/632,620, which is incorporated herein by reference in its entirety.

### BACKGROUND OF THE INVENTION

1. Field of the Invention

The present invention generally relates to a universal set-top box chip that can process and demodulate multiple inputs including inputs from satellite, cable, Internet, USB, DSL, or other devices. The set-top box also includes Ethernet and USB connections so as to receive inputs from other set-top boxes with similar connections.

2. Background Art Set-top boxes are commonly used to receive and decode digital television broadcasts and to interface with the Internet through the user's television instead of a PC. Set-top boxes fall into several categories, from the simplest that receive and unscramble incoming television signals to the more complex that will also function as multimedia desktop computers that can run a variety of advanced services.

Conventional set-top boxes are configured for specific types of delivery systems. For instance, conventional satellite configurations use a different set-top box from that used by a cable system.

What is needed is a universal set-top box configuration that can be integrated on a single semiconductor substrate, and that can process any type of input regardless or its origin.

### BRIEF SUMMARY OF THE INVENTION

A universal integrated set-top box is implemented on single semiconductor substrate, which is configured to process digital input signals (e.g. MPEG packets) that can represent TV or movie programming for example.

The set-top box is a universal set-top box chip that can process and demodulate multiple different types of programming inputs including satellite, cable, Internet, or other device inputs. This can be accomplished because the set-top box does not have a specific tuner integrated on the substrate, and therefore can take generic down-converted digital inputs, e.g. MPEG packets. In other words, an external tuner/decoder (of any type) can be connected to the set-top box input for processing, including for example, a satellite tuner, a cable tuner, or any other type of tuner/decoder that can produce digital outputs (e.g. MPEG packets) for further processing in a set-top box. The set-top box also includes Ethernet and universal serial bus (USB) connections so as to receive inputs from other set-top boxes, Internet devices, or other devices, with similar types of connections. Therefore, the universal set-top box device is able to use the digital packets to transfer and display images via the Internet. Further, the USB connection enables the set-top box device to transmit and receive digital data (including video and audio MPEG packets) through the USB connection, which could even be connected to another set-top box that is local or remote.

In further embodiments, the universal set-top box includes one or more memory interfaces, such as a disk drive interface. The digital packets are stored on the memory (hard-drive or other memory device) to allow program viewing at a non-real time rate, such as in TiVo applications, or at a later time.

Further features and advantages of the present invention, as well as the structure and operation of various embodiments of the present invention, are described in detail below with reference to the accompanying drawings.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a universal single-chip set-top box according to embodiments of the present invention.

FIG. 2 illustrates the universal single-chip set-top box having multiple possible inputs.

FIG. 3 illustrates a flowchart of the universal set-top box operation.

### DETAILED DESCRIPTION OF THE INVENTION

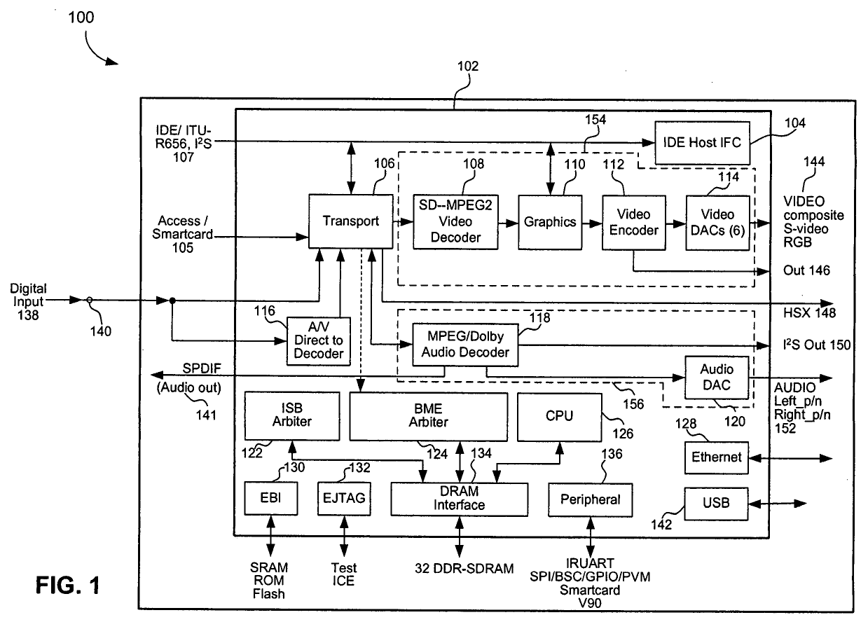

FIG. 1 illustrates a universal integrated set-top box that is implemented on single semiconductor substrate. For example, the substrate can be CMOS or another processing material. More specifically, FIG. 1 illustrates a set-top box 100 that is implemented on a common substrate 102. The set-top box 100 includes video and audio baseband functions on the common substrate 102. The set-top box 100 is a universal set-top box chip that can process and demodulate multiple different types of inputs including satellite, cable, Internet, or other device inputs. This can be accomplished because the set-top box 100 does not have a specific tuner integrated on the substrate 102, and therefore can take generic down-converted inputs, e.g. MPEG packets. In other words, an external tuner/decoder (of any type) can be connected to the set-top box input for processing, including for example, a satellite tuner, a cable tuner, or any other type of tuner/decoder that can produce digital outputs (e.g. MPEG packets) for further processing in a set-top box. The set-top box 100 also includes Ethernet and USB connections so as to receive inputs from other set-top boxes, Internet device, or other devices, with similar types of connections.

The set-top box 100 includes an external hard-drive memory interface 104, transport module 106, video decoder 108, graphics module 110, video encoder 112, video digital-to-analog converter 114, Direct TV decoder 116, audio decoder 118, audio digital-to-analog decoder 120, Internal System Bus (ISB) Arbiter 122, Media Engine (e.g. Broadcom Media Engine) BME arbiter 124, CPU 126, Ethernet 128, EBI interface 130, EJTAG 132, DRAM interface 134, peripheral interface 136, and universal serial bus (USB) 142.

The set-top box 100 operates as follows. The input port 140 receives a digital input signal 138 that can be any type of digital input, including a satellite digital input, cable digital input, etc. The digital input signal can carry television or movie programming, for example. Typically, the digital input has already been down-converted to an IF signal or baseband signal consistent with set-top box operation. For example, the digital input signal 138 can be in the form of digital MPEG packets that include both audio data and digital data.

The transport module 106 receives the digital input signal and separates the audio data from the video data in the MPEG packets. The transport module 106 sends the video data to the video decoder 108 and sends the audio data to the audio decoder 118. Alternatively, either of the audio or video data can be exported external to the chip via the HSX output 148 as shown in FIG. 1. The transport module 106 can also be accessed or controlled via a smartcard interface 105.

If the input digital signal is encoded by some proprietary means, such as Direct TV, then the input digital signal is decoded by the decoder 116 prior to distribution to the transport module 106.

The video decoder 108 decodes the video data and passes the decoded video data to the graphics module 110. After processing, the output of the graphics module 110 is sent to the video encoder 112, and then to the video DAC 114. The graphics module 110 can be used to add text to the output of the video decoder 108. The video DAC 114 converts the video signals to analog for output to the S-Video output 144 for display on a conventional television set, or other display. The output 146 can be used if a customer of the chip desires to use a video DAC that is external to the substrate 102. The video decoder 108, graphics module 110, video encoder 112, and the video DACs 114 can be summarized as a video module 154 (as shown in FIG. 1) that receives the digital video portion (MPEG packets) from the output of the transport module 106 and generates the video outputs 144 and 146.

The audio decoder 118 receives the audio data from the transport module 106, and decodes the audio data for the audio DAC 120. The audio decoder 118 can include an MPEG Dolby audio decoder if appropriate. The audio DAC 120 receives the audio data and converts the digital audio data to analog for output at the audio output 152. The audio decoder 118 also provides a SPDIF output 141, where the audio out 152 is of higher quality than the SPDIF output 141 as will be understood by those skilled in the arts. The audio decoder 118 also includes an output 150 if it is desired to bypass the audio DAC 120, for example, to use external audio DACs that are specialized for a particular application. The MPEG Dolby decoder 118 and the audio DAC 120 can be summarized as an audio module 156 (as shown in FIG. 1) that generates the audio output 152.

In addition to video and audio display as discussed, the set-top box 100 can also store the digital input signal to an external memory (not shown) using the external memory interface 104. For example, MPEG packets that comprise the digital input 8 can be stored in an external hard drive via the external memory interface 104. Therefore, the stored data can then be retrieved later for processing and viewing using the video module 154 and the audio module 156. This can include TiVo-like processing functions including rewind, play-back, and pause functions, and more.

Further, the set-top box 100 can also store the digital input signal to an external or internal DRAM device (not shown) connected to the DRAM interface 134 and the BME arbiter 124. The BME arbiter 124 determines the priority that a transport, audio, graphics, or video client gets when accessing the DRAM device via the DRAM interface 134. The DRAM device can be use in conjunction with the external hard drive during data storage. More specifically, digital input data 138 that is destined to be stored on the external hard drive, is often received at a data rate that is too fast for the hard drive to process and store. Accordingly, the DRAM device offers a temporary fast storage, before down-load to the hard drive via the hard drive interface 104. An internal data bus (not shown) connects the various components including the BME arbiter 124, transport 106, IDE Host 104 and transfers data between the various components so that data can be stored between the DRAM device and external hard-drive. IDE Host 104 can also be accessed or controlled by an IDE interface 107.

The set-top box 100 further includes an Ethernet Interface 128 and a Universal Serial Bus (USB) interface 142. The Ethernet Interface 128 is capable of communicating and receiving Ethernet traffic (including Internet traffic), so that IP packets can be received over the Internet and processed through the set-top box 100 for program viewing. For example, in one embodiment, DVD movies (e.g. Netflix) are down-loaded over the Internet to the Ethernet interface 128 for processing. A movie can be downloaded and viewed in realtime, or the movie can be down-loaded to a hard drive for later viewing. Additionally, the USB Interface 142 is capable of connecting to a Universal Serial Bus that can be used to receive MPEG packets for processing in the set-top box 100. For example, the USB interface 142 can be used to send MPEG packets from one set-top box to another set-top box for processing and display. By doing so, one or more set-top boxes (in a home or a building for example) could be networked together so that programming (movies, etc.) could be shared among the set-top boxes.

The set-top box 100 further includes a peripheral interface 136 for interfacing to peripherals such as remote controls, etc. The set-top box 100 further includes an EBI interface 130 for a SRAM flash ROM, and a EJTAG test interface 132.

Further details will now be described regarding the various functions of the set-top box 100. For instance, the transport module 106 is capable of processing multiple independent transport streams concurrently, including streams from the digital input 138 and one or more internal playback channels. The transport module 106 is also capable of processing MPEG and Direct TV transport streams concurrently.

The video decoder 108 can decode both MPEG packets and direct TV formats. In embodiments of the invention, the decoder 108 provides variable frame rate support. For example, the decoder 108 can support 25 frames per second for a 625 line television system, 29.97 frames per second for 525 lines television system. In embodiments, the video decoder includes a horizontal filter (e.g. 8 tap), a vertical filter (e.g. 4 tap), and vertical chroma filter. The video decoder also includes various error detection schemes such as: detection of illegal codewords, automatic discharge of slices that are out of picture range, recovery from lost picture headers, detection and recovery of skipped pictures, automatic discard of unsupported picture coding types, etc.

The audio decoder 118 can decode various digital standards, including 5.1 Dolby digital, and MPEG layer 1 and layer 2 audio. The decoder can support compressed Dolby on SPIDIF output simultaneously with decompression of MPEG or Dolby on the DAC output. The decoder includes selectable Direct TV or MPEG formats for the input. The decoder can decode multiple sample rates including, for example, 32, 44.1, and 48 kHz. The audio decoder 118 can implement two channel down-mix for Dolby digital. The audio decoder includes various error detection and correction schemes.

The graphics module 110 includes various image pixel formats and alpha blending types including 3 full screen 16 bits per pixel surfaces with one video tunnel and one 2 bit 64×64 cursor at 704×480 resolution. The graphics module supports two-dimensional video scaling.

The video encoder supports integrated NTSC/PAL/SECAM encoder with Macrovision support, sync and color burst generation, DC level offset, color space conversion, luminance and chroma filtering, X/SIN(X) compensation filters, close captioning, etc.

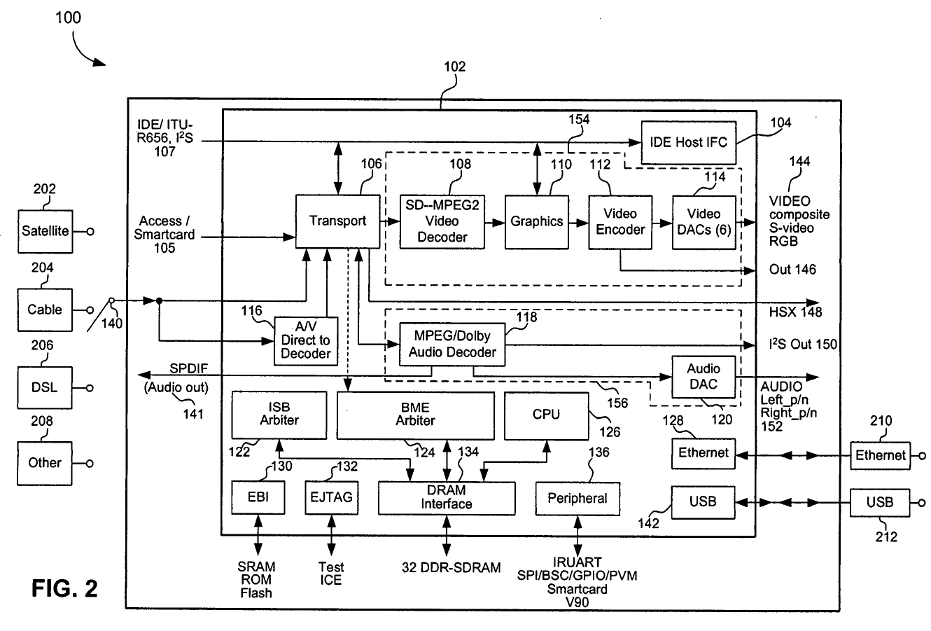

As discussed above, the set-top box 100 is a universal set-top box that operates with any number and type of inputs, and that integrates the audio/video backend on a common substrate. FIG. 2 further illustrates this concept as discuss below.

FIG. 2 illustrates the set-top box 100 implemented with a satellite down-converter input 202, a cable down-converter input 204, a DSL input 206, or some other input 208, where the set-top box 100 can select among any of these inputs. FIG. 2 further illustrates an Ethernet connection 210, or a USB connection 212, connected to corresponding interfaces on the set top box 100. This is provided so that the MPEG packets can be received over the Internet or Ethernet device, or via a USB connection. In other words, FIG. 2 further emphasizes the universal nature of set-top box 100, in that the set-top box 100 can process programming from a number of different types of inputs including: satellite 202, cable 204, DSL 206, and others 208, as well as Ethernet 210 and USB 212.

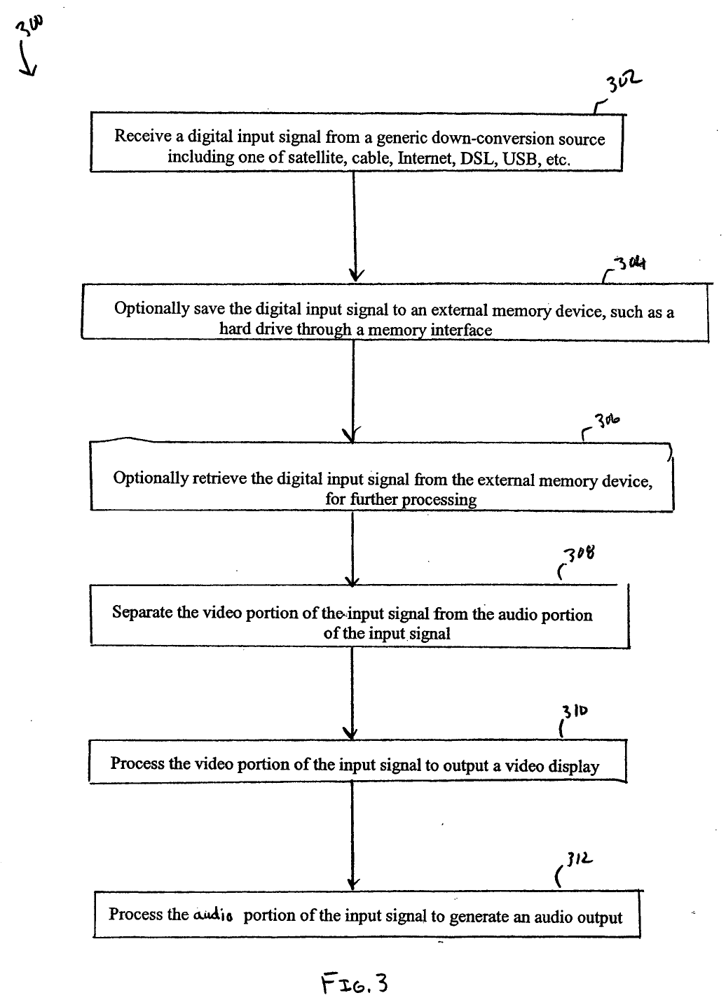

FIG. 3 further illustrates the operation of the set-top box 100 according to embodiments of the present invention. In step 302, a digital input signal is received that has previously been down-converted and demodulated from any number of sources, including satellite, cable TV, etc. The digital input signal could also be received over an Ethernet connection, including the Internet. The digital input signal could also be received via a USB connection. The digital input signal can be implemented in a number of standards including: MPEG packets, internet packets, etc, and preferably contains television programming or Internet traffic consist with set-top box operation.

In step 304, the digital input signal can optionally be saved to an external memory device, such as a hard drive through the memory interface 104, so that the programming could be viewed/played at a later time, such as in a TiVo application. Prior to saving on the hard drive, the digital input signal could also be temporarily saved to some other type of memory device, including a DRAM device through the DRAM interface 134. This can typically occur when the input data is being received at a rate that exceeds the ability of the memory interface 104 to save the data to the external hard drive, so the DRAM device becomes a temporary storage.

In step 306, the digital input signal is optionally retrieved from the external memory device, if necessary, so that further processing can occur.

In step 308, the video portion of the digital input signal is separated from the audio portion of the digital input signal. For example, the transport module 106 separates video MPEG packets from audio MPEG packets. The video MPEG packets are forwarded for video processing and the audio MPEG packets are forwarded for audio processing.

In step 310, the video portion of the digital input signal is further processed, to produce a video composite S-Video output. This can include video decoding 108, audio graphics processing 110, video encoding 112, and video DACs 114 to produce the S-Video output 144.

In step 312, the audio portion of the digital input signal is further processed, to produce a left right audio output signal 152. This can include Dolby audio decoding 118 and the audio digital-to-analog decoder 120.

### CONCLUSION

Example embodiments of the methods, systems, and components of the present invention have been described herein. As noted elsewhere, these example embodiments have been described for illustrative purposes only, and are not limiting. Other embodiments are possible and are covered by the invention. Such other embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed is:

1. A set-top box, comprising:
a common substrate;
an input port for receiving a digital input signal;
a divider module, coupled to said input, separating a video portion from an audio portion of said digital input signal;
a video module, coupled to said divider module output, for processing said video portion of said digital input signal;
an audio module, coupled to said divider module output, for processing said audio portion of said digital input signal;
an Ethernet interface; and
a universal serial bus (USB) interface;
said input port, said divider module, said video module, said audio module, and said Ethernet interface, all disposed on said common substrate.

2. The set-top box of claim 1, wherein said input port is coupled to one of:
a satellite receiver, a cable receiver, and a DSL receiver, one of which provides said digital input signal.

3. The set-top box of claim 1, further comprising a first memory interface disposed on said common substrate.

4. The set-top box of claim 3, wherein said digital input signal is down-loaded to a first external memory device connected to said first memory interface.

5. The set-top box of claim 4, further comprising a second memory interface disposed on said common substrate, said digital input signal temporarily down-loaded to said second memory interface prior to storage in said first external memory device.

6. The set-top box of claim 5, wherein said first memory interface is a hard drive interface and said first external memory device is a hard drive, and said second memory interface is a DRAM interface, and said second external memory device is a DRAM.

7. The set-top box of claim 1, further comprising a satellite decoder coupled to said input.

8. The set-top box of claim 1, wherein said common substrate is a CMOS substrate.

9. The set-top box of claim 1, wherein said video module receives said video portion and generates a video output from said video portion.

10. The set-top box of claim 1, wherein said audio module receives said audio portion and generates an audio output from said audio portion.

11. The set-top box of claim 1, wherein said digital input signal includes Moving Picture Experts Group (MPEG) packets.

12. The set-top box of claim 11, wherein said divider module separates video MPEG packets from audio MPEG packets.

13. The set-top box of claim 12, wherein said video module processes said video MPEG packets to produce a video output, and said audio module processes said audio MPEG packets to produce an audio output.

14. The set-top box of claim 13, wherein said video module includes the following:
a video decoder that decodes said video MPEG packets;
a graphics module, coupled to an output of said video decoder, that adds text to said video MPEG packets;
a video encoder, coupled to an output of said graphics module; and
a video digital-to-analog converter that converts an output of said video encoder to analog.

15. The set-top box of claim 13, wherein said audio module includes:
an MPEG audio decoder that receives and decodes said audio MPEG packets; and
an audio digital-to-analog converter, coupled to an output of said MPEG audio decoder, that converts an output of said MPEG audio decoder to analog.

16. The set-top box of claim 1, wherein said Ethernet Interface is configured to receive a second digital input signal over an Internet connection for processing in said set-top box.

17. The set-top box of claim 1, wherein said USB interface is configured to receive a third digital input signal over a USB cable or a wireless USB connection.

18. The set-top box of claim 1, further comprising a peripherals interface, disposed on said common substrate.

19. The set-top box of claim 1, wherein the digital input signal represents television programming.

20. A method of processing a digital input signal in a set-top box, comprising:
receiving the digital input signal;
separating a video portion of the digital input signal from an audio portion of the digital input signal;
processing the video portion of the digital input signal to produce a video output; and
processing the audio portion of the digital input signal to produce an audio output.

21. The method of claim 20, wherein the digital input signal is received from one of the following: a satellite receiver, a cable receiver, a DSL receiver, an Ethernet connection, and a USB connection.

22. The method of claim 20, further comprising the steps of:
storing the digital input signal to an external memory device.

23. The method of claim 20, wherein the external memory device is a hard drive.

24. The method of claim 23, further comprising the step of temporarily storing the digital input signal to a DRAM prior to storage in the hard drive device.
